(19) United States
(12) Patent Application Publication
(10) Pub. No.: US 2016/0125533 A1
(43) Pub. Date: May 5, 2016

(54) SYSTEM AND METHOD FOR SIMULATING A LIVE TRADING MARKET

(71) Applicant: GORDIAN INNOVATIVE TECHNOLOGIES, LIMITED, County Dublin (IE)

(72) Inventor: Richard Vance Davis, New Smyrna Beach, FL (US)

(73) Assignee: GORDIAN INNOVATIVE TECHNOLOGIES, LIMITED, County Dublin (IE)

(21) Appl. No.: 14/527,927

(22) Filed: Oct. 30, 2014

(51) Int. Cl. G06Q 40/04

(52) U.S. Cl. CPC G06Q 40/04

(57) ABSTRACT

A method, market test system and computer program product simulate a live, reactive trading market to test an electronic trade strategy. An incoming historical market data feed is received and modified for re-execution. Securities orders are received from an electronic trade strategy and from the modified historical market data feed. Each securities order is tagged to identify a source of origin. Securities orders are executed according to a full market model of a target trading venue. The executed orders are analyzed to identify the source of origin. A price modification value is calculated based on executed orders originating from the electronic trade strategy. The price modification value is used to modify prices of securities orders in the incoming historical market data feed. The incoming historical data feed may be modified by removing “executes.” A configurable personality profile may be applied to alter behavior of the simulated trade market.

### BACKGROUND OF THE INVENTION

1. Field of the Invention

The present invention relates to simulation of financial markets and more specifically to the testing of electronically executed trading strategies.

2. Description of the Related Art

Today the majority of securities trading on a public or private exchange is being executed electronically via automated algorithms. Unfortunately, these algorithms typically are not tested or poorly tested prior to being released on the live trading market as there has been no way to accurately simulate an evolving market. As a result, there have been instances where a new algorithmic strategy has severely failed, causing drastic economic loss to the participants using the new strategy as well as other participants in the market at large.

There have been three major developments in financial markets that have directly affected the requirement for live market testing: expansion of electronic trading, increased risk and regulatory requirements.

Algorithmic trading, as a proportion of all trading, has greatly expanded over the last decade. Prior to the turn of the century, algorithmic trading represented a small percentage of all trades. The risks from this electronic trading were present, but they were not considered critical to the safety of a market or individual trading firms. Today, algorithmic trading represents 85% of trade volume in many markets. This shift has increased both the visibility of the risks and potential scope of impact of a failure due to the lack of the ability to do live market testing.

There have been a few very visible failures in the market due to the absence of competent testing in the market. One of the more notable failures was the recent closure of Knight Trading due to this exact issue. Trading firms no longer view the need to test algorithms as a mere regulatory requirement. Rather, the lack of testing represents a real risk to the continued viability of an organization.

Additionally, regulatory agencies throughout the world are now singularly focused on setting targeted requirements for testing of trade algorithms prior to permitting the particular algorithm to enter the market. Some regulators have stated openly that the markets either fix this problem or high frequency algorithms will be banned. For example, in the USA, the Securities and Exchange Commission (SEC) and Commodity Futures Trading Commission (CFTC) are openly discussing legislation and asking for input on regulations requiring testing of trade algorithms. In the European Union, the European Securities and Markets Authority (ESMA) signed directives in May, 2012 requiring all trade algorithms to be tested prior to execution in the live market. The directives are being implemented into regulations via the Markets in Financial Instruments Regulations (MiFIR) initiative this year. Additionally, Hong Kong's Security and Futures Commission (SFC) has mandated testing as a part of their code of conduct.

To this point, there have generally been two categories of testing technology used by trading firms that execute automated trading strategies: conformity testing and strategy validation.

For conformity testing, all trading venues provide test systems for trading firms to verify their ability to connect to the venue, submit messages, read and respond to messages. These systems are rudimentary open book systems with no real market data sets or live market capabilities. Basically, the goal of these systems is merely to verify that the trading firms can connect to and communicate with the trading venue in the proper format. Conformity testing technology is mature, competent, and is in widespread use throughout the financial markets industry.

On the other hand, strategy validation technologies intended to test the operational efficiency of electronically executed algorithmic strategies according to risk evaluation, regulatory requirements and efficiency in executing trade orders as intended. Trade algorithms often produce tens of thousands of transactions (bids, asks, cancels) per second. These automated transactions occur without human control or oversight. This lack of control or oversight represents a significant risk to trading firms.

Known strategy validation technologies all have one major inherent defect: they do not provide representative simulations of how the strategy will behave when executed in a live market. Rather, only rudimentary testing can be accomplished and as a result does not provide a solution for any of the three levels of testing described above. Current algorithm test technology generally consists of a market replay engine to replay historical data against a matching engine to create recreation of a target venue's market at a point in time. The market replay engine re-executes trade messages from an historical market data set and sends this information to a generic matching engine. With intelligent execution, the market replay engines are able to recreate the market on the matching engine as it existed on the day represented by the historical data. The level of accuracy of varies with the level of intelligent execution. Traders wishing to test their electronic algorithms interface to the generic matching engine as they would the live market and execute their strategies.

The shortcomings of market replay engine based technology are due to the matching engine's reaction to new messages being inserted into the execution stream. These new trading messages had not actually occurred as part of the historical data. The new messages change the market, either totally obviating some of the replayed transactions or, at least, causing the matching engine to respond to historical transactions in a manner that makes no sense. These new transactions can materially change the market (e.g., turns a long order into a short order). In addition, much of execution efficiency, and therefore profitability, is dependent upon timing within the market. As the new messages are executed in the matching engine timing becomes unrealistic with expectations. In addition, since the matching engine is generic, it will not behave in a manner equivalent to the target trading venue. In summary, market replay engine technology forces improper or invalid execution of both historical data and new trading messages.

At best, market replay engine technology only provides the trader with the ability to accomplish rudimentary modeling of their strategies for statistical variability. It does not provide for a true representation of the market being tested as new messages obviate the historical reactions, nor for a reactive moving market or the ability to modify the market's personality to test specific scenarios.

Because of the above, trade algorithms are currently tested in the live market with a conservative execution strategy. Conservative execution requires complex safety switches and limited volumes. Limiting the risk in this manner, in itself, can significantly modify a strategy's reaction as compared to execution with full volume and with the lessened processing overhead of expanded safety switches. As a result, even with conservative initial execution, strategies are implemented without a real understanding of its reaction within a live market as well as no understanding of the strategy's impact upon that market.

Until recently the live market testing of a trade algorithm has been an unspoken truth. Regulators, trading firms, and trading venues have all been uncomfortable with the reality of no actual testing of strategies running in the live market.

Therefore, a need exists to accurately simulate a moving, reactive market to allow for testing of electronic trade algorithms prior to release on a live trading market.

### BRIEF SUMMARY OF THE INVENTION

Embodiments of the present invention address deficiencies of the art in respect to limitations in accurately modeling a moving, reactive trading venue and provide novel and non-obvious methods, system and computer program product for testing new electronic trade algorithms.

Existing methods attempt to simulate a live market environment by replaying an historical data stream and introducing orders from an electronic trade strategy into the system based on a generic matching engine. However, these methods cannot accurately model a moving, reactive market because as soon as an event occurs that did actually happen when the historical data was live, the historical data is changed. In addition, they do not model a specific trading venue's reactions to historical data provided. Existing methods simply cannot react to the electronic trade strategy under test, therefore results from this testing are inaccurate.

In accordance with one aspect of the present disclosure, this method uses a different approach by creating a model of a market that is a mirror image of trading venues execution rather than a simulation. In addition, this method modifies the historical data according to effects caused by the electronic trade system under test, thereby allowing the market model to react and move. The market test system receives an incoming historical market data feed and modifies the incoming historical market data feed for re-execution by removing all “executes.” Securities orders are received from an electronic trade strategy and from the modified historical market data feed. Each securities order is tagged to identify a source of origin. Securities orders are executed according to a model of the market that is built to mirror the behavior of a target trading venue. The executed orders are analyzed to identify the source of origin. A price modification value is calculated based on executed orders originating from the electronic trade strategy and used to modify prices of securities orders in the incoming historical market data feed.

In accordance with another aspect of the present disclosure, the system is configurable to simulate different target trading venues using classes defined according to the published rules and the execution methodology of the target venue. Additionally, extreme or unusual conditions may be simulated to stress the system using personality profiles that are also defined by user enterable parameters.

In accordance with yet another aspect of the present disclosure, all components of the market test system may be self-contained within a single device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a system for analyzing testing an electronic trade strategy in a moving, reactive market, in accordance with aspects of the present disclosure;

FIG. 2 is a block diagram of an example order gateway of the system of FIG. 1 in accordance with aspects of the present disclosure;

FIG. 3 is a flow chart illustrating an example method of simulating processing orders of an electronic trade strategy in a moving, reactive market, in accordance with aspects of the present disclosure;

FIG. 4 is a block diagram of an example market engine of the system of FIG. 1 in accordance with aspects of the present disclosure;

FIG. 5 is a flow chart illustrating an example method of fulfilling orders in a particular simulated venue in accordance with aspects of the present disclosure;

FIG. 6 is a block diagram of an example market data engine of the system of FIG. 1 in accordance with aspects of the present disclosure; and

FIGS. 7 and 8 are flow charts illustrating example methods of modifying an historical trading data feed to reflect changes incurred by the application of a new electronic trading strategy in accordance with aspects of the present disclosure.

### DETAILED DESCRIPTION OF THE INVENTION

An embodiment of the invention provides for a system and method of simulating financial markets to test electronically executed trading strategies prior to releasing the electronic trade strategy into a live market. An embodiment of the present disclosure provides the first truly reactive market test systems and represents a complete testing platform. The market test system re-executes historical market data in a manner that creates a representative of a targeted test market which allows movement as algorithms to be tested are executed. The market test system also provides the ability to change the personality of the test market to simulate specific market events and/or stress conditions and provides a matching engine that can simulate a target trading venue.

One embodiment of the present disclosure includes the above functionality, as well as support functions (e.g., gateways, monitoring, and reporting) in a single contained, configurable, and competent testing environment. This allows trading firms and traders to test independently and on demand.

In order to be viable, a solution needs to meet a base set of functional requirements. The market has been building a consensus on the requirements of a credible solution. Operational implementation of the market test system should provide repeatable, verifiable, and on demand execution across trading venues. A trading venue is any entity that provides a matching service for buyers and sellers of financial instruments. These entities can be divided into three categories: Regulated Exchanges, Alternative Trading Systems (ATS), and brokers that offer specialized matching services as part of their sell side services.

Thus, the market test system should be re-executed with repeatable reactions and results. Otherwise, problem determination will be difficult and the confidence in a corrective solution will be low. Additionally, the test execution should be verifiable so that the performance is structured and consistent by limiting external variability while still providing a robust test. If a test's complexity is due to a large number external variables it will be difficult to ascertain the root cause of disorderly reaction or, worse, hide the disorderly reaction all together. Finally, traders need to be able to execute a test on demand, when needed and with specific market data across all applicable venues. Accomplishing on demand implementation while still providing a repeatable and verifiable test is a challenge. If this functional component is not delivered, then traders will not consistently use the test facility, negating the purpose of regulatory certification.

The system and methods of the present disclosure delivers operational performance that is repeatable, verifiable, and provides on demand execution across multiple trading venues. The market test system emulates a reactive market exchange because a simple replay of historical market data does not allow a test platform to react to new trades being introduced. In the case of an historical market data replay, as soon as a trade is entered that actually did not happen, the historical data model is changed. For example, shares that the test algorithm buys may not actually be available. The challenge to building a true market emulator is to quantitatively define the behavior of a specific market and to rebuild the market based on that behavior taking into account both the historical market data as well as new transactions being executed.

Due to the operational requirements, the market test system should not be shared as other test algorithms may affect the electronic trade strategy under test. The market test system includes a matching engine that is able to simulate a target trading venue.

In addition, the market test system is able to modify a market's personality to ascertain a strategy's reaction to multiple conditions. Testing an electronic trade algorithm in a normally executing market is not sufficient. Typically, an algorithm's reactions to markets are created as a result of a cascade of many strategies reacting to an event. That event may have been caused by a single strategy, thus testing in a normally executing market may have ferreted out this single strategy. However, a normally executing market will not test the reactions of others to the algorithm itself. In other words, to be a viable test both testing the cause (i.e. to avoid bad behavior) and effect (i.e. the ability to react to a condition) have to be tested.

The market test system also includes automated reporting and logging to certify test results as regulators will require proof of testing prior to allowing an algorithm to execute in the live market.

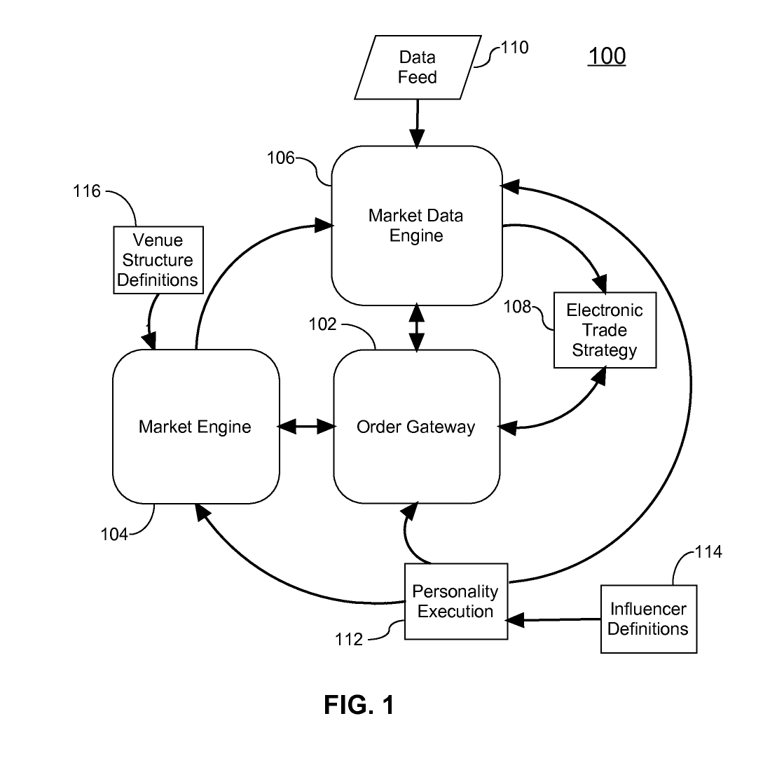

Referring now to FIG. 1, the market test system 100 includes an order gateway 102, a market engine 104 and a market data engine 106. An electronic trade strategy 108 to be tested simulates an actual trader by sending orders (e.g., ask, bid or cancel) to the order gateway 102 for processing. The order gateway 102 accepts securities orders from the electronic trade strategy 108 as well as modified orders from other historical data feeds 110 via the market data engine 106 and tags each order to identify the originating source. The order gateway 102 is also in communication with a personality executor 112 to modify the orders according to a current personality profile as determined by a set of influencer definitions 114. Operation of the personality executor 112 is discussed in more detail below. The order gateway 102 acts as a traffic cop to control the flow of orders to the market engine 104.

The market engine 104 fulfills orders by executing pending securities orders (e.g., matches an ask order for a particular stock with a bid order for that stock when the price indexes are the same). The market engine 104 is configurable to act as a particular market venue by way of venue structure definitions 116 which characterize the operational functionality of a particular venue. Additionally, the market engine 104 is also in communication with the personality executor 112 and may alter its operation in accordance with the current personality profile. The market engine 104 pre-publishes one consolidated data stream containing all transactions and messages to the market data engine 106 and a trader-specific data stream containing transaction responses back to the order gateway 102.

The market data engine 106 publishes the executed orders back to the electronic trade strategy 108 and modifies the incoming historical data stream 110 to simulate how the electronic trade strategy 108 affects the historical data stream 110. It should be noted that the market test system 100 may source multiple data feeds, although FIG. 1 shows a single data feed 110 solely for the purposes of illustration and clarity. The market data engine 106 receives the pre-published listing of executed orders and analyzes the published listing to determine which orders originating from the electronic trade strategy 108 are fulfilled. The market data engine 108 maintains an ongoing store of current prices for each stock that has been executed. If the published orders have affected the price of any stock (i.e. the price of the last executed order for a particular stock has shifted the price up or down by any amount), the market data engine 106 stores the new price and the delta between the new price and the last known price and uses that delta to modify incoming orders from the historical data feed 110. Additionally, the operation of the market data engine 106 may also be modified by the personality executor 112 to conform to the current personality profile.

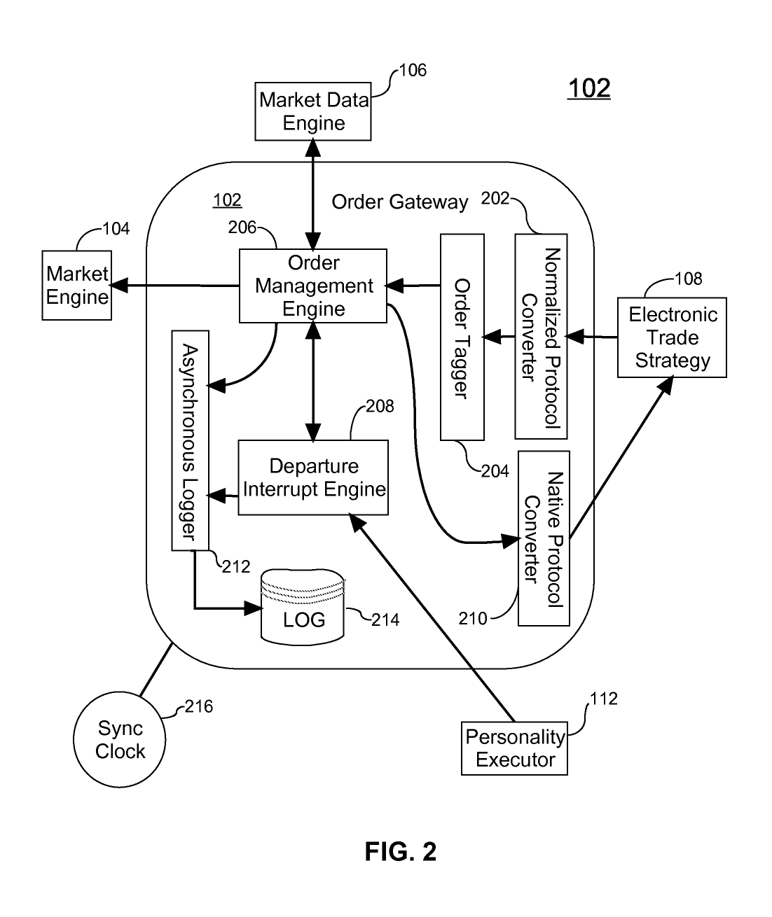

Turning now to FIG. 2, the primary components of an example order gateway 102 may include a normalized protocol converter 202, an order tagger 204, an order management engine 206, a departure interrupt engine 208 and a native protocol converter 210 for receiving and managing orders. In addition, an asynchronous logger 212 records all operations performed by the order management engine 206 in log files 214.

It is important to note that the order gateway 102, the market engine 104 and the market data engine 106 are all connected to the same synchronous clock 216. By having all the elements in the system operating according to the same clock, delays are eliminated and the market test system 100 is able to operate at speeds much faster than real-time. Using current technology, the market test system 100 can operate multiple times faster than real time, allowing a full day's trading to be simulated in a matter of minutes.

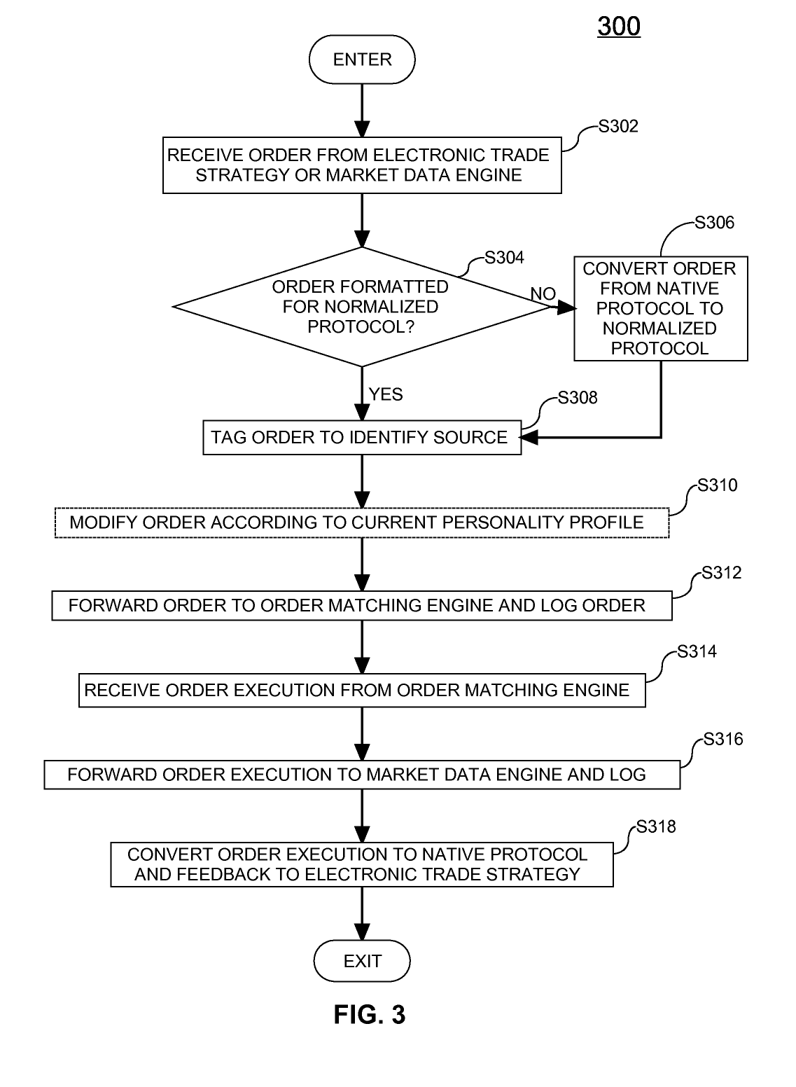

Operation of the example order gateway 102 is illustrated by the process depicted in flowchart 300 of FIG. 3. The order gateway 102 receives (at step S302) an order from the electronic trade strategy 108 under test or from the market data engine 106 originating via the historical data feed 110. As there are many different protocol formats that may be used by various electronic trade strategies, the market test system 100 operates using a normalized protocol tailored specifically for this functionality. Orders originating from the electronic trade strategy 108 will be in their own native protocol (e.g., MITCH, Financial Information eXchange (FIX), FIX Adapted for Streaming (FAST), etc.), while orders arriving via the market data engine 106 will have already been converted to the normalized protocol. If the incoming order is not (at step S304, “NO” branch) in the normalized protocol, the normalized protocol converter 202 converts (at step S306) the order to the normalized protocol.

Each order is tagged (at step S308) by the order tagger 204 to identify the source of the order. For example, every order originating from the electronic trade strategy 108 receives a non-anonymous unique source identifier so that these orders may be tracked through the system and their effect on other trades may be evaluated. In addition, if multiple electronic trade strategies 108 are being tested simultaneously, orders from different electronic trade strategies 108 receive a different source identifier. Each order from an historic data feed 110 receives a different non-anonymous identifier that identifies from which data feed the order originated. Alternately, orders originating from the historic data feed 110 may effectively be “tagged” simply by not receiving a specific identifier, thus allowing the system to identify non-tagged orders as originating from the historic data feed 110. Additionally, spurious orders that may be generated by the departure interrupt engine 208 are also given a different non-anonymous identifier. The process of non-anonymizing incoming orders is unique to the market test system 100 and allows the market test system 100 to specifically pinpoint actions and effects caused by the electronic trade strategy 108.

The departure interrupt engine 208 of the order gateway 102 may optionally modify (at step S310) the incoming orders or affect the operation of the order management engine 206 according to instructions from the personality executor 112. The personality executor 112 is used to modify normal market conditions and stress the electronic trade strategy 108. Each of the order gateway 102, the market engine 104 and the market data engine 106 includes its own departure interrupt engine 208, 404, 610 which applies the appropriate information for their corresponding components. The personality executor 112 includes personality profiles configured such that the personality executor 112 knows which departure interrupt engine or engines 208, 404, 610 to invoke for a particular profile. All the actions of the personality executor 112 are written using a user modifiable set of rules and parameters that interface with the order gateway 102, the market engine 104 and the market data engine 106 to create behavior of the market test system 100 that would be expected to cause most events that would influence a market's operations. The personality executor 112 is intended to simulate unusual events that, while not commonly occurring, do occasionally affect the market. For example, during a “triple witching hour” which occurs on the third Friday of every March, June, September and December when three different types of securities (stock options, stock market index futures and stock market index options) simultaneously expire, the volume of orders (as well as volatility) can increase drastically. To simulate this phenomenon, the personality executor 112 can artificially increase the orders to be processed by instructing the departure interrupt engine 208 to spuriously create additional orders. Other events, such as a “flash crash” which is characterized by a very rapid, deep and volatile drop in prices occurring within an extremely short period of time, may be simulated by “buying” all pending orders of a particular security in the order book and placing a large number of small orders so that there are a large number of sellers, but no buyers, causing the price to drop. Events may be modeled by modifying order sizes, modifying the depth of the book, modifying distribution of order sizes, modifying order volumes of a security, modifying cancel volumes of a security, modifying price spreads, creating a call market, spuriously creating new orders, speeding up or slowing down order processing, and providing random delays in external or internal connections.

The configurable market personality variables include, but are not limited to, a news climate variable; a market volume variable; a volatility variable; a bid/ask spread variable; an options expiration variable; a government action variable such as a Federal reserve meeting/interest rate variable and an election season variable; an age of market variable (bull/bear); earnings season variables such as percent of reporting complete and a ratio of hits to misses on forecasts variable; order flow variables such as ratio of orders placed to cancels variable, ratio of buy orders to sells variable, ratio of buy orders to cancels variable, ratio of sell orders to cancels variable and ratio of buy cancels to sell cancels variable. Additional market specific variables may include trade halt variables, news pending variables, IPO variables, additional location-specific market variables, market delay variables, order size variables (e.g., small, large, massive), war event variables, and a number of orders variable by types (e.g., a large number of small orders). These parameters are user-entered and stored as influencer definitions 114. The influencer definitions 114 control not only the value of certain variables, but may also define which sets of code will be executed for different circumstances. For example, the personality executor 112 may instruct the market engine 104 to slow down or speed up the processing of orders.

Returning now to FIG. 3, the order management engine 206 forwards (at step S312) the orders to the market engine 104 and the transaction is recorded into a log 214 by the asynchronous logger 212. Executed orders or notification thereof are received (at step S314) from the market engine 104 by the order management engine 206, forwarded (at step S316) to the market data engine 106 and logged by the asynchronous logger 212. Additionally, the executed orders or notification are converted (at step S318) back to the electronic trade strategy's 108 native format by the native protocol converter 210 and fed back to the electronic trade strategy 108.

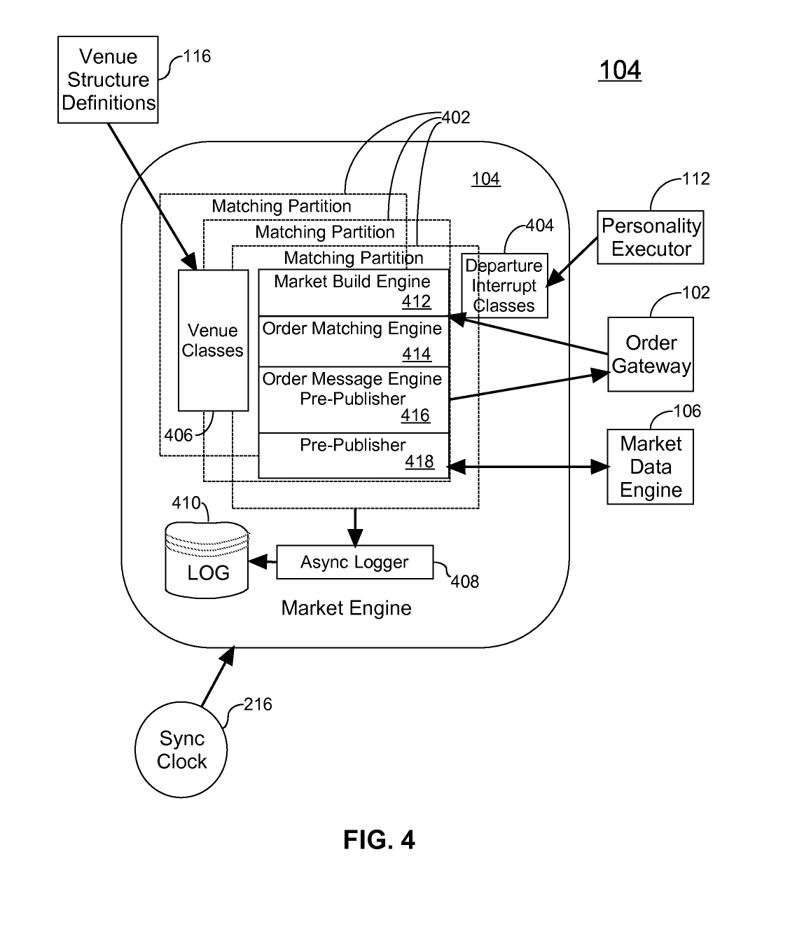

Turning now to FIG. 4, example market engine 104 includes a plurality of matching partitions 402 which are influenced by departure interrupt classes 404 and venue classes 406. Each matching partition 402 mirrors a partition of a particular trade venue and includes a market build engine 412 for the market's orders structure used in the operation of the matching partition 402 according to parameters and classes set in the departure interrupt classes 404 and venue classes 406. The venue classes 406 are determined according to the venue structure definitions 116. Actions of the matching partitions 402 are recorded by an asynchronous logger 408 into log files 410. Each matching partition 402 further includes an order matching engine 414, an order message engine pre-publisher 416 and a pre-publisher 418 for executing and publishing orders.

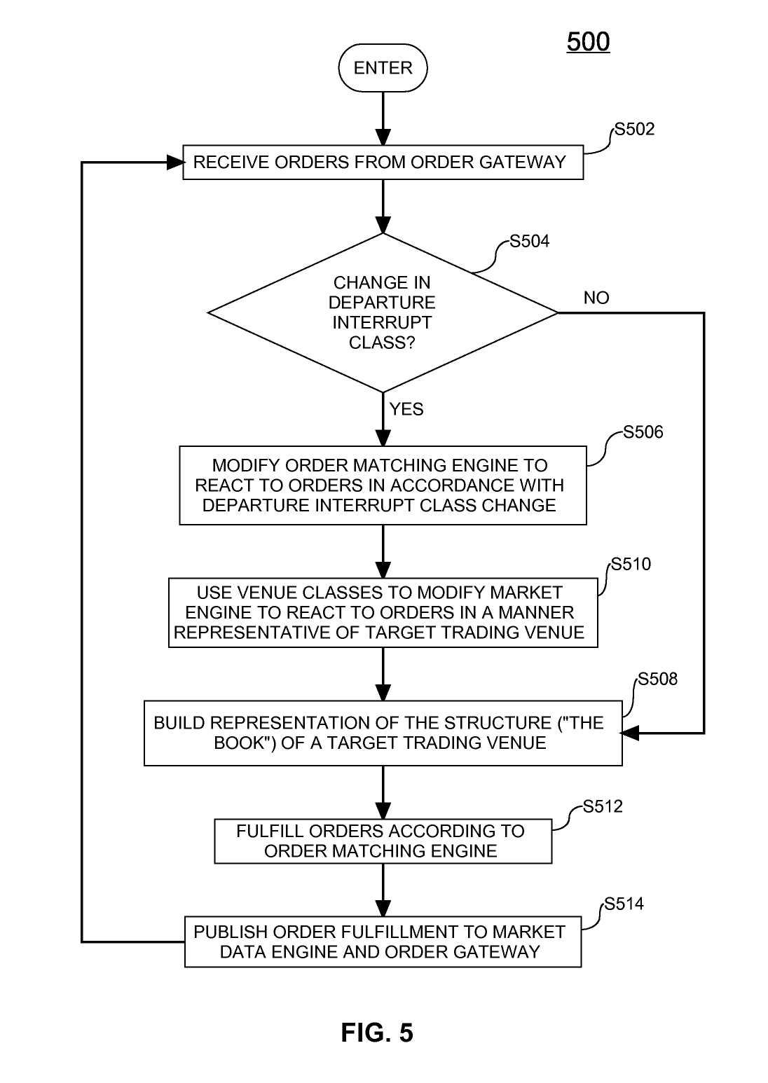

FIG. 5 is a flowchart 500 which depicts an example method of operation for the market engine 104. Beginning at step S502, the market build engine 412 receives orders for fulfillment from the order gateway 102. Optionally, if the personality executor 112 has made any changes to the departure interrupt classes 404 (at step S504), the operation of the order matching engine 414 is modified (at step S506) to conform to the requirements of the current personality profile. The classes and instructions provided by the venue classes 406 are used to modify (at step S508) any or all of the market build engine 412, the order matching engine 414, the order message pre-publisher 416 and the pre-publisher 418 to react to orders in manner representative of the target trading venue. The market build engine 412 uses these rules and incoming orders to build (at step S510) a representation of the structure of the target trading venue commonly known as “the book.” The book contains the entirety of the available securities including all bids and asks. The order matching engine 414 fulfills (at step S512) the outstanding orders whenever possible by matching like bids with asks. Fulfilled orders (e.g., canceled or executed orders) are published (at step S514) to the order gateway 102 by the order message engine pre-publisher 416 and to the market data engine 106 by the pre-publisher 418. The orders published to the order gateway 102 are only orders specific to a certain trader (i.e. the electronic trade strategy 108). However, the data published to the market data engine 106 contains all the consolidated information for the entire market and is commonly known as a market data feed. The market data feed includes executes, orders, indexes and cancels for every trader, as well as, other informational messages. It should be noted that a matching engine in a live market exchange would actually publish the market data feed, however, in the market test system 100, the market data feed may be subject to additional modifications by the market data engine 106 before actual publication.

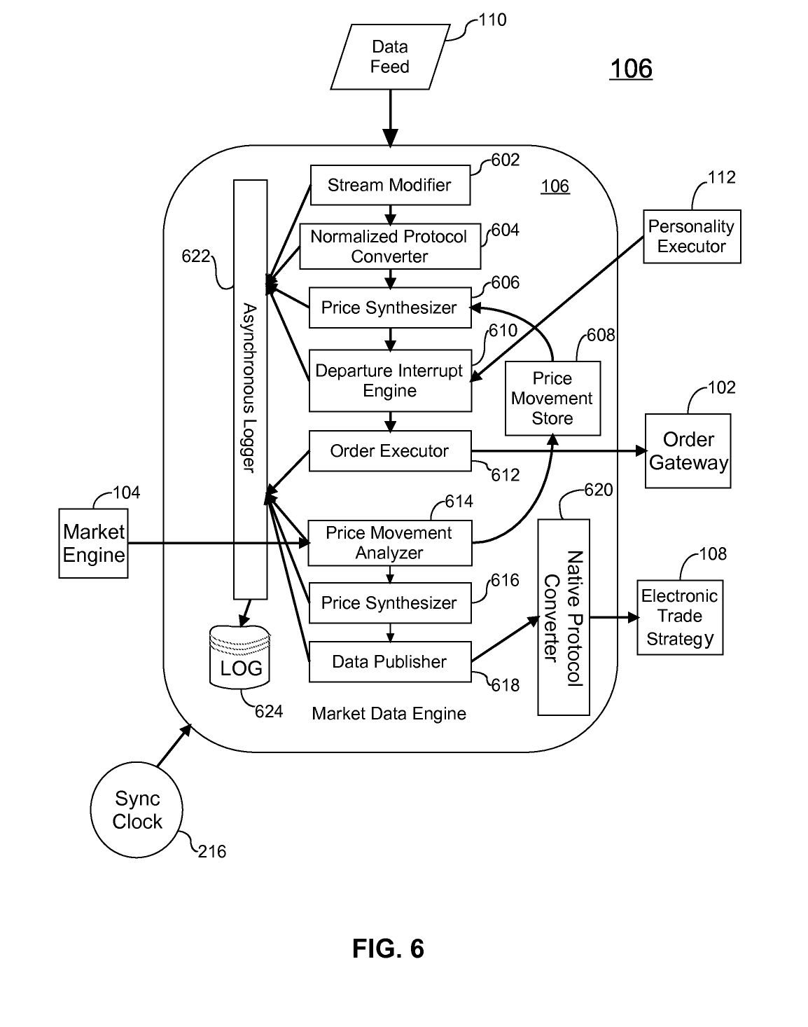

Referring now to FIG. 6, a block diagram illustrating an example market data engine 106 is provided. The example market data engine 106 serves three purposes: to modify the historical data stream for execution by the market test system 100, to analyze the orders executed by the market engine 104 to determine how the electronic trade strategy 108 under test actually affects the market and to publish the market data feed to the electronic trade strategy 108. The example market data engine 106 includes a stream modifier 602, a normalized protocol converter 604, a first price synthesizer 606, a price movement store 608, a departure interrupt engine 610 and an order executor 612 for processing the information from the historical data feed 110. Additionally, the example market data engine 106 includes a price movement analyzer 614, a second price synthesizer 616, a data publisher 618 and a native protocol converter 620 for analyzing the actual executed orders received from the market engine 104 and feeding this information back to the electronic trade strategy 108 under test. All actions occurring within the market data engine 106 are logged by an asynchronous logger 622 in one or more logs 624.

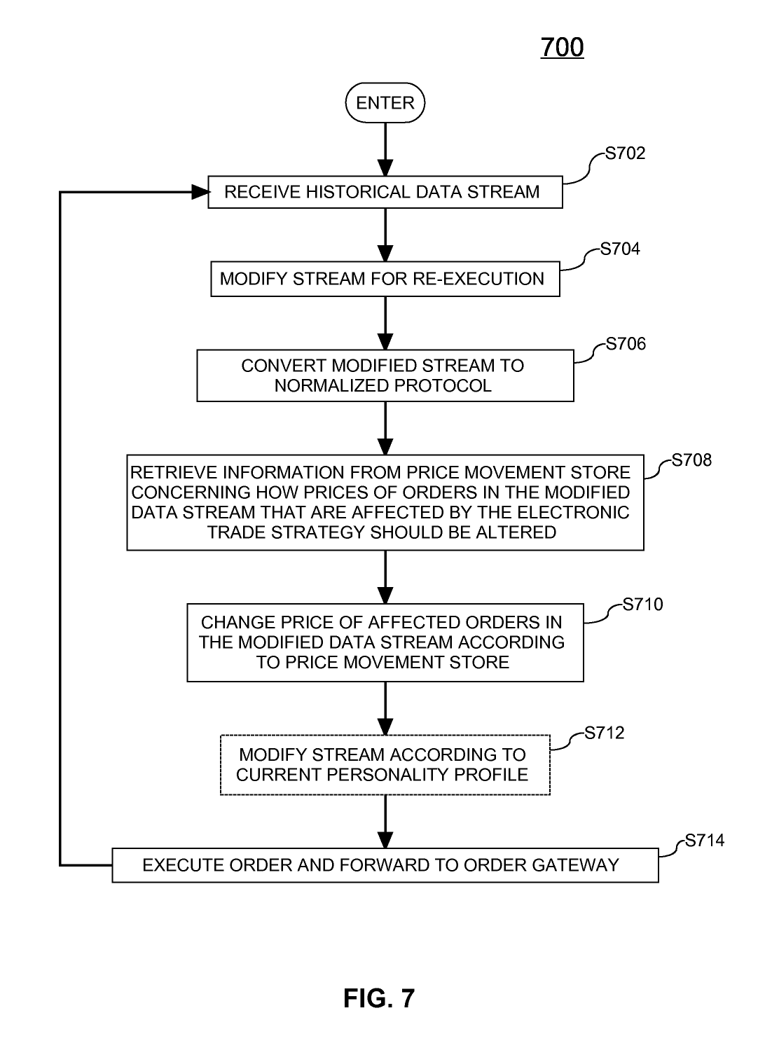

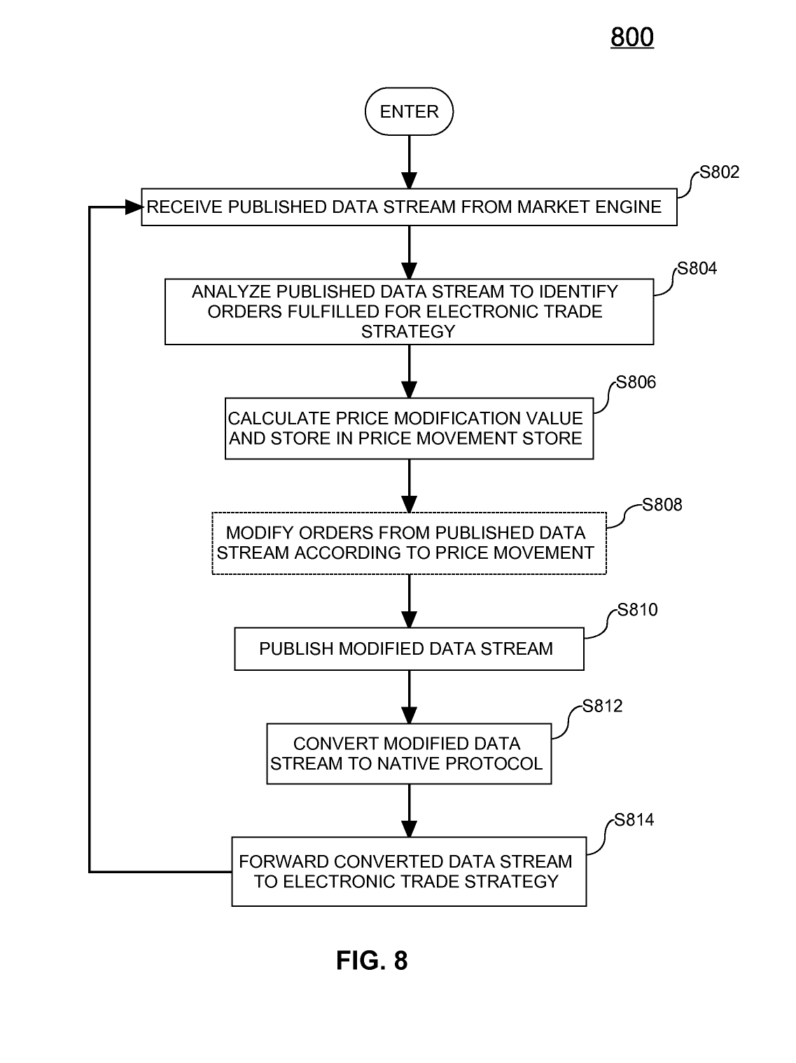

Turning to FIGS. 7 and 8, example methods of operation of the market data engine 106 are illustrated in flowcharts 700 and 800. Beginning at step S702, the market data engine 106 receives at least one historical data stream. The stream modifier 602 modifies (at step S704) the stream for re-execution by removing all “executes.” This modification allows the matching engine 402 of the market test system 100 to re-execute the orders from the historical data stream itself, allowing the market to move and react to situations caused as a result of introducing the electronic trade strategy 108 into the market. The normalized protocol converter 604 operates in the same manner as the normalized protocol converter 202 of the order gateway 102 and converts (at step S706) the modified data stream from its native protocol into the normalized protocol used by the market test system 100. The first price synthesizer 606 retrieves (at step S708) information from the price movement store 608 concerning how prices of orders in the modified data stream that have been affected by the electronic trade strategy 108 should be altered and changes (at step S710) the price of any affected order according to this information. The first price synthesizer 606 modifies the historical data stream to reflect the new prices, thus the prices at which the historical data stream submits orders are modified accordingly. In addition, the departure interrupt engine 610 may also modify the historical data stream (at step S712) in accordance with the current personality profile as described above. The order executor 612 executes (at step S714) the orders from the modified historical data stream and forwards each order to the order gateway 102.

In analyzing the actual orders executed by the market engine 104, the price movement analyzer 614 receives (at step S802) the published data stream from the market engine 104 and analyzes (at step S804) the published data stream to identify any order fulfilled for the electronic trade strategy 108. The price movement analyzer 614 is able to identify the source of an order due to the order tagging performed by the order gateway 102 prior to matching. The price movement analyzer 614 calculates (at step S806) a price modification value and stores the value in the price movement store. The price modification value is the difference between a last traded price of a particular stock originating from the historical data and the price of the last received fulfilled order of that stock originating from the electronic trade strategy 108. The value stored in the price movement store 608 is used in the process of FIG. 7 to adjust the historical data stream. In addition, the second price synthesizer 616 may modify (at step S808) the prices of orders in the published data stream, if required, according the current personality profile. The data publisher 618 publishes (at step S810) the modified data stream by first forwarding the data stream to the native protocol converter 620 to convert (at step S812) the data stream into the native protocol used by the electronic trade strategy 108 and then forwarding (at step S814) the converted stream back to the electronic trade strategy 108.

An embodiment of the present invention improves upon existing methods by 1) re-executing historical market data in a manner that creates a representative test market that allows movement as algorithms being tested execute, 2) providing the ability to change the personality of the test market to simulate specific market events and/or stress conditions, 3) providing a matching engine that can simulate a target trading venue, 4) logging activities and events at every state for correlation and analysis, and 5) including the above functionality, as well as support functions (gateways, monitoring, and reporting) in a contained, configurable, and competent testing environment, allowing trading firms and traders to test independently and on demand.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of simulating a live, reactive trading market to test an electronic trade strategy, comprising:
receiving an incoming historical market data feed;
modifying the incoming historical market data feed for re-execution;
receiving securities orders from an electronic trade strategy and the modified historical market data feed;
tagging each securities order to identify a source of origin;
executing matched securities orders according to a model mirroring a target trading venue;
analyzing the executed orders to identify the source of origin;
calculating a price modification value based on executed orders originating from the electronic trade strategy; and
modifying prices of securities orders in the incoming historical market data feed using the price modification value.

2. The method of claim 1, wherein modifying the incoming historical data feed comprises removing all “executes.”

3. The method of claim 1, wherein the matching engine simulates a target trade venue using defined set of venue structure definitions implemented through a set of reusable classes.

4. The method of claim 1, wherein calculating a price modification value comprises:
determining a price of a security in an executed order originating from the electronic trade strategy; and
calculating a difference in the price of the security in the executed order originating from the electronic trade strategy and the price of the same security last executed from an order originating from the historical data feed.

5. The method of claim 1, further applying a configurable personality profile to alter behavior of the simulated trade market.

6. The method of claim 5, wherein the personality profile is configurable using variables defining at least one of a news climate, a market volume, a volatility, a bid/ask spread, an options expiration, a government action, an age of market, a percent of reporting complete, a ratio of hits to misses on forecasts, an order flow, a trade halt, pending news, an IPO, a location-specific market condition, a market delay, a massive order, a war event, and a large number of small orders.

7. The method of claim 5, wherein the personality profile alters the behavior of the simulated trade market by at least one of:
modifying order sizes;
modifying a depth of book;
modifying distribution of order sizes;
modifying order volumes of a security;
modifying cancel volumes of a security;
modifying price spreads;
creating a call market;
spuriously creating new orders;
speeding up order processing;
slowing down order processing;
providing random delays in external connections:
providing random delays in internal connections; and
buying all pending orders of a particular security.

8. The method of claim 1, further comprising publishing the executed orders back to the electronic trade strategy.

9. The method of claim 8, further comprising:
converting the incoming historical market data feed and the received securities orders from the electronic trade strategy to a normalized protocol; and
converting the published executed orders to a protocol native to the electronic trade strategy.

10. A market test system for simulating a live, reactive trading market to test an electronic trade strategy, comprising:
an order gateway configurable to:
receive securities orders from an electronic trade strategy and a modified historical market data feed; and
tag each securities order to identify a source of origin;
a market engine, communicatively coupled to the order gateway, the market engine configurable to execute matched securities orders according to a matching engine modeling a target trading venue; and
a market data engine, communicatively coupled to the order gateway and the market engine, the market data engine configurable to:
receive an incoming historical market data feed;
modify the incoming historical market data feed for re-execution;
analyze the executed securities orders to identify the source of origin;
calculate a price modification value based on executed orders originating from the electronic trade strategy; and
modify prices of securities orders in the incoming historical market data feed using the price modification value.

11. The market test system of claim 10, further comprising a synchronous clock coupled to the order gateway, the market engine and the market data engine.

12. The market test system of claim 11, wherein the order gateway, the market engine, the market data engine and the synchronous clock are contained within a single device.

13. The market test system of claim 10, wherein the matching engine simulates a target trade venue using venue classes defined by rules and executing methodologies of the target trade venue.

14. The market test system of claim 10, wherein the market data engine calculates a price modification value by:
determining a price of a security in an executed order originating from the electronic trade strategy; and
calculating a difference in the price of the security in the executed order originating from the electronic trade strategy and the price of the same security last executed from an order originating from the historical data feed.

15. The market test system of claim 10, further comprising a personality executor communicatively coupled to the order gateway, the market engine and the market data engine, the personality executor configurable to apply a personality profile to alter behavior of the simulated trade market.

16. The market test system of claim 15, wherein the personality profile is configurable using variables defining at least one of a news climate, a market volume, a volatility, a bid/ask spread, an options expiration, a government action, an age of market, a percent of reporting complete, a ratio of hits to misses on forecasts, an order flow, a trade halt, pending news, an IPO, a location-specific market condition, a market delay, a massive order, a war event, and a large number of small orders.

17. The market test system of claim 15, wherein the personality profile alters the behavior of the simulated trade market by at least one of:
modifying order sizes;
modifying a depth of book;
modifying distribution of order sizes;
modifying order volumes of a security;
modifying cancel volumes of a security;
modifying price spreads;
creating a call market;
spuriously creating new orders;
spuriously creating new cancels;
speeding up order processing;
slowing down order processing; and
providing random delays in external connections:
providing random delays in internal connections; and
buying all pending orders of a particular security.

18. The market test system of claim 10, wherein the market data engine is further configurable to publish the executed orders back to the electronic trade strategy.

19. The market test system of claim 18, wherein:
the order gateway is further configurable to convert the received securities orders from the electronic trade strategy to a normalized protocol; and
the market data engine is further configurable to convert the incoming historical market data feed to a normalized protocol and convert the published executed orders to a protocol native to the electronic trade strategy.

20. A computer program product for simulating a live, reactive trading market to test an electronic trade strategy, the computer program product comprising a computer readable storage medium having program instructions embodied therewith, the program instructions executable by a device to cause the device to perform a method comprising:
receiving, by the device, an incoming historical market data feed;
modifying, by the device, the incoming historical market data feed for re-execution;
receiving, by the device, securities orders from an electronic trade strategy and the modified historical market data feed;
tagging, by the device, each securities order to identify a source of origin;
executing, by the device, securities orders according to a matching engine simulating a target trading venue;
analyzing, by the device, the executed orders to identify the source of origin;
calculating, by the device, a price modification value based on executed orders originating from the electronic trade strategy; and
modifying, by the device, prices of securities orders in the incoming historical market data feed using the price modification value.
